(19) United States
(12) Patent Application Publication
(10) Pub. No.: US 2008/0282355 A1
(43) Pub. Date: Nov. 13, 2008

(54) DOCUMENT CONTAINER DATA STRUCTURE AND METHODS THEREOF

(76) Inventors: John E. Nemazi, Bloomfield Hills, MI (US); James W. Proscia, Dearborn, MI (US); Hersh H. Mehta, Rochester Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/119,265

(22) Filed: May 12, 2008

Related U.S. Application Data
(60) Provisional application No. 60/917,658, filed on May 12, 2007.
(60) Provisional application No. 60/938,185, filed on May 15, 2007.

(51) Int. Cl. G06F 21/00; G06F 7/06; G06F 17/30

(52) U.S. Cl. 726/26; 707/100; 707/102; 707/3; 707/1; 707/E17.008; 707/E17.014

(57) ABSTRACT

Several embodiments of the present invention take the form of a file-container data structure encoded in a computer readable medium for storing files and associated metadata in a manner so that the integrity of such files are maintained and verifiable. Some embodiments take the form of a method for forming a file-container data structure. Several embodiments take the form of a method for viewing file-container data structures Some embodiments take the form of a method for authenticating a file-container data structure.

### CROSS-REFERENCE TO RELATED APPLICATIONS

This application claims the benefit of U.S. provisional application Ser. No. 60/917,658, filed May 12, 2007, and U.S. provisional application Ser. No. 60/938,185, filed May 15, 2007. The entire disclosures of these applications are hereby incorporated by reference.

### BACKGROUND

1. Field

Embodiments of the present invention relate to document container data structures and methods thereof.

2. Background Art

Electronic discovery (e-discovery) has become an integral part of the civil litigation process, fostered by an awareness that a large proportion of evidence is digital in nature. In conducting electronic discovery, problems can arise with respect to the vast quantities of electronic data that must be reviewed, whether for a party's document production in litigation against another party, for satisfying government reporting requirements, or for some other relevant legal purpose. A party's ability to manage information in these scenarios often depends on how readily it can capture, review, assess, and produce relevant documentation.

Metadata, such as that associated with a given electronic data file, is typically stored to the file's host device. Such metadata can include information, such as, but not limited to, a file's creation date, author, or storage path. The gathering of partial or erroneous data or metadata can have profound implications on an electronic discovery process.

### SUMMARY

Against the background set forth above, several embodiments of the present invention take the form of a container data structure encoded in a computer readable medium. The container data structure can be useful for storing files and associated metadata in a manner so that the integrity of such files is maintained and verifiable. The container data structure includes file data copied from a first target file. In a variation, such file data is includes data generally viewed by a user as the content of the file. The first target file is encoded on a target digital storage medium from which a user desires to copy files without changing content or metadata. The container data structure also includes metadata associated with the first target file. The metadata includes original access-time information, original creation-time information, original modified-time information, and an original file path.

Several embodiments take the form of a method for forming a container data structure, including, but not limited to, the data structure previously described. The method includes copying the first target file to a storage location to form the file data copied from a first target file and associating a copy of the original metadata with the file data copied from a first target file.

Several embodiments take the form of a method for viewing container data structures, including, but not limited to the data structure previously described. The method includes providing a user with a listing of file data and/or metadata included in the container data structure.

Several embodiments take the form of a method for authenticating a file container data structure encoded in a computer readable medium. The container data structure includes file data derived from one or more target files. Container data structures useable in these embodiments include, but are not limited to, the container data structures previously described. The method includes associating a hash value with the container data structure and then requiring authentication of the hash value as a prerequisite to viewing content in the container data structure.

### DRAWINGS

Several embodiments of the present invention may be best understood by referring to the following detailed description in conjunction with the accompanying Figures, in which:

FIG. 1a shows a diagram of an environment in which embodiments of the present invention can operate;

FIG. 1b shows a diagram of another environment in which embodiments of the present invention can operate;

FIG. 1c shows a diagram of another environment in which embodiments of the present invention can operate;

FIG. 1d shows a diagram illustrating examples of various types of target machines an investigating machine can access over a network;

FIG. 2a shows an embodiment of a document-container data structure according to an embodiment of the present invention;

FIG. 2b shows another embodiment of a document-container data structure according to an embodiment of the present invention;

FIG. 3a shows an aspect of a document-container data structure according to an embodiment of the present invention;

FIG. 3b shows another aspect of the document-container data structure according to an embodiment of the present invention;

FIG. 4 shows a diagram illustrating a method for indexing a document-container data structure according to an embodiment of the present invention;

FIG. 5 shows a diagram illustrating a method for forming a document-container data structure according to an embodiment of the present invention;

FIG. 6a shows a flow diagram illustrating a method for creating a document-container data structure according to an embodiment of the present invention;

FIG. 6b shows a flow diagram illustrating a method for viewing a file stored in a document-container according to an embodiment of the present invention;

FIG. 6c shows a flow diagram illustrating a method for authenticating a document-container data structure according to an embodiment of the present invention;

FIG. 7a shows a diagram illustrating a method for merging multiple document-container data structures according to an embodiment of the present invention;

FIG. 7b shows a diagram illustrating a method for extracting one or more files from a document-container data structure to create one or more new document-containers data structures; and

FIG. 8 shows pseudo code that programmatically illustrates a method for creating a document-container data structure according to an embodiment of the present invention.

The Figures are not necessarily to scale and may be simplified for clarity.

### DETAILED DESCRIPTION

The present invention is not limited to the specific embodiments described below. Rather, the disclosed embodiments are exemplary of the invention, which may be embodied in various and alternative forms. Therefore, specific details should not be interpreted as limiting, but as a representative basis for teaching a skilled artisan to employ the present invention.

As used in this section and unless otherwise indicated: the term “embodiment” refers to “embodiment of the present invention”; the terms “a”, “an”, and “the” comprise plural referents; and all numerical quantities are modified by the word “about”.

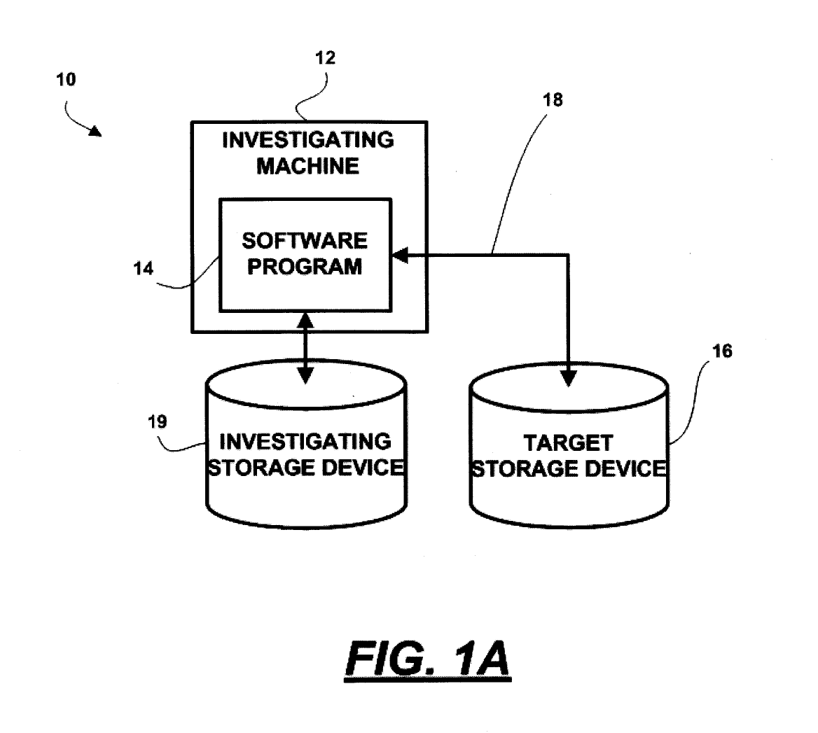

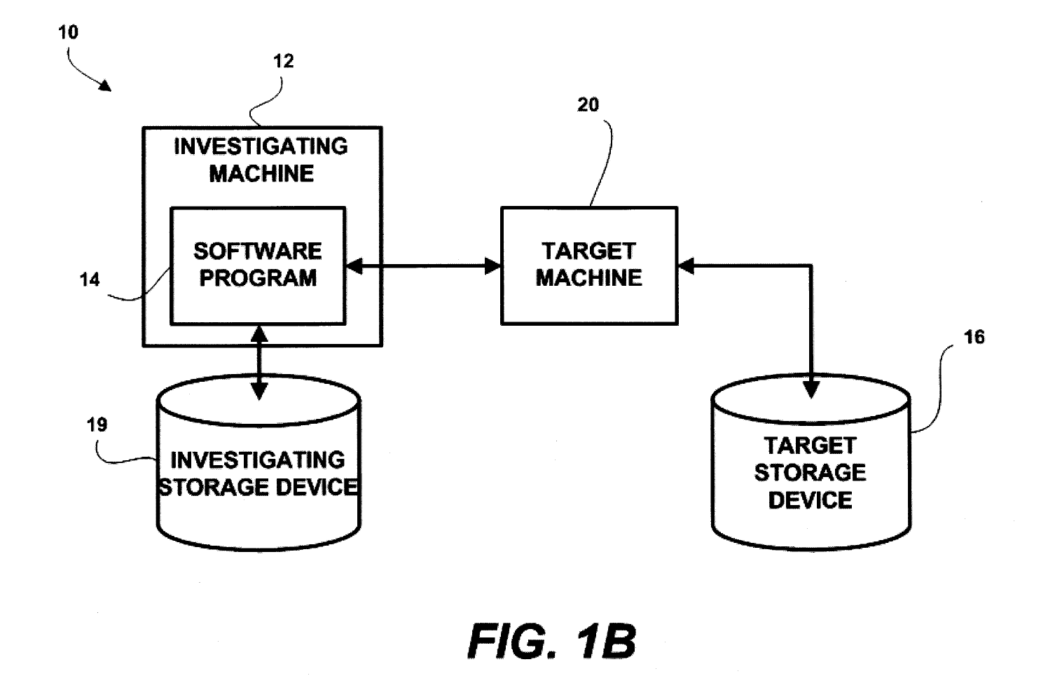

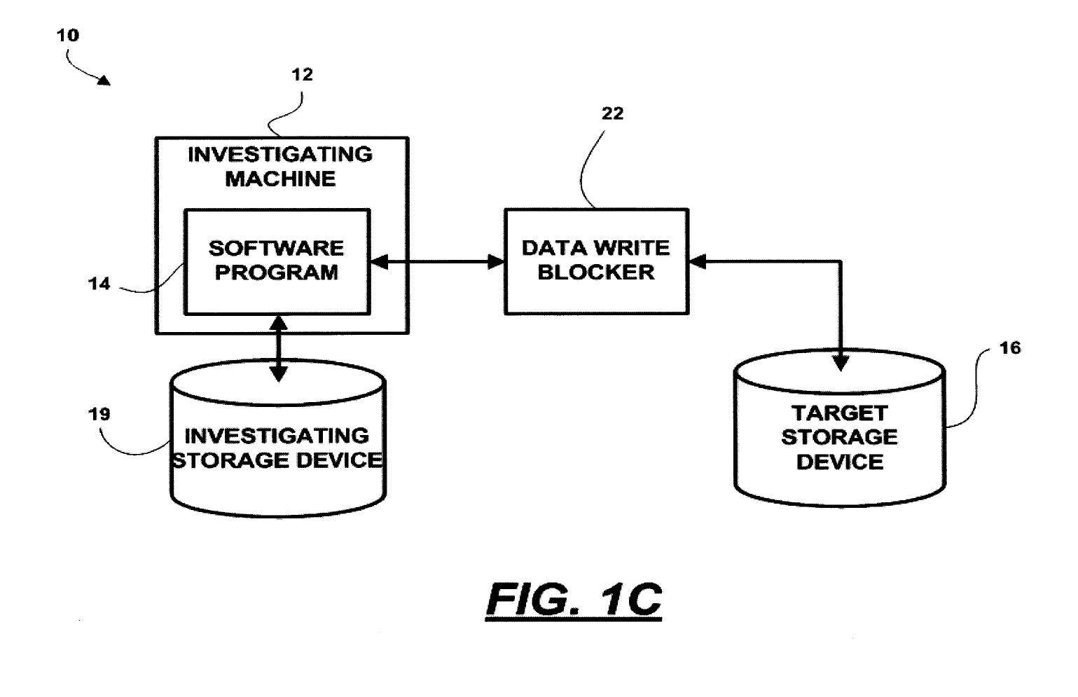

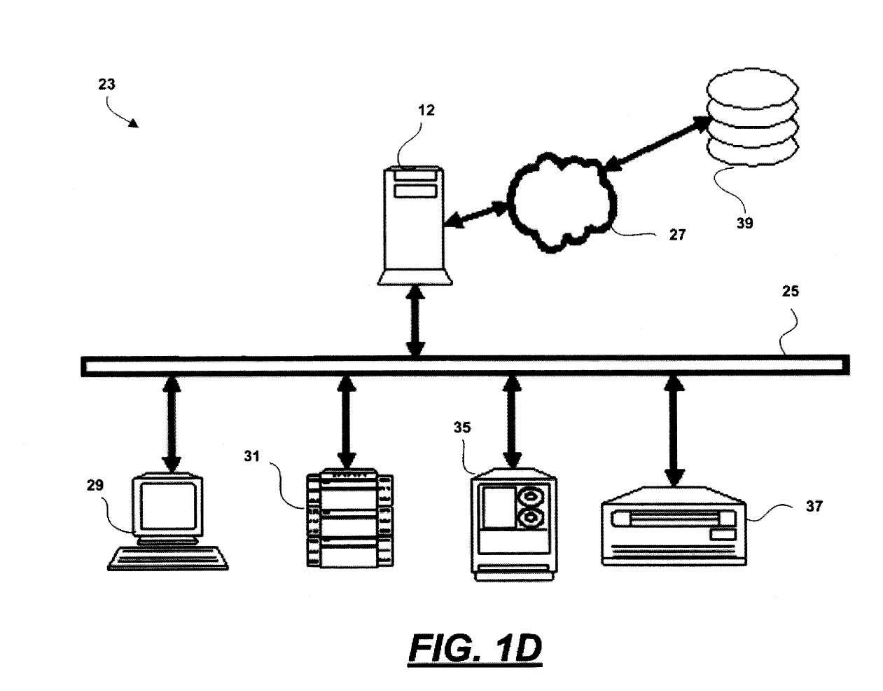

FIG. 1a shows an environment in which an electronically-stored document-container data structure (hereforth “document container” and “container”) and methods thereof may be implemented. A system 10 includes an investigating machine 12 configured to execute instructions delivered thereto by a software program 14, and a target storage device 16 in communication with the investigating machine 12 via a communication link 18. The target storage device 16 has data encoded thereon. The investigating machine 12 can be any suitable computing device capable of executing computer-readable instructions, including, but not limited to, a server, a laptop computer, or a personal digital assistant. The investigating machine 12 can be a portable device, such as, but not limited to, a Universal Serial Bus (USB) device, a Compact Flash (CF) memory card, or a Standard Digital (SD) memory card. For example, the software program 14 can run on a virtual machine (not shown) encoded on a USB device that functions as the investigating machine 12.

The target storage device 16 may include one or more physical storage mediums. Types of physical storage mediums include, but are not limited to, hard disk drives, flash memory devices, and/or redundant arrays of inexpensive disks (RAID).

In several embodiments, the software program 14 facilitates communication between a user of the investigating machine 12 and the target storage device 16 to retrieve information and store the information to a document container (not shown in FIG. 1a).This process is explained in greater detail in the following disclosure.

The communication link 18 between the investigating machine 12 and the target storage device 16 can include any suitable apparatus for transferring information between the investigating machine 12 and the target storage device 16. Such apparatus includes, but is not limited to, one or more cabless, a radio-frequency antenna pair, and/or one or more optical fibers.

As shown in FIG. 1b, one or more target machines 20 may host and/or communicate with the target storage device 16. The target machine(s) may facilitate communication between the software program 14 and the target storage device 16. As an example of such a scenario, a personal computer may host a hard disk drive. Here, the personal computer would correspond to the target machine 20, and the hard disk drive would correspond to the target storage device 16. FIG. 1c shows an environment, according to an embodiment, in which a document container and methods thereof may be implemented. As shown, a write-blocking element 22 is placed between the investigating device and the storage device. The purpose of the write-blocking element 22 is to prevent the software program 14 from altering the information on the target storage device 16. The write-blocking element 22 can couple to the investigating machine 12 and the target storage device(s) 16 in a variety of ways, for example via USB, SCSI, IDE, and/or SATA. Such a device can be useful in a scenario where the user of an investigating machine 12 desires to preclude the altering of information on the target storage device 16. As an alternate, or in addition, to using a write blocker, a user could initialize the target storage device 16 in a secure read-only mode, such as, for example, a Linux read-only boot or a Microsoft Windows safe mode boot.

FIG. 1d shows a diagram illustrating examples of various types of target machines an investigating machine can access over a network in accordance with the present invention. The examples set forth are not inclusive, and the investigating machine may access other types of target machines. As shown, the investigating machine 12 is in communication with multiple devices 29-37 via a local area network (LAN) 25 and with another device 39 via a wide area network (WAN) 27. The local area network can be any network where devices generally associate with one another in a generally local proximity, for example, a collection of networked computers within a company. A wide area network may be a broader network such as the internet. The investigating machine 12 can associate with devices over the local area network 25; such as network machines 29, servers 31, tape drives 35, and other storage devices 37; and/or devices over the wide area network to extract select file information and its associated metadata. The target devices shown in FIG. 1d can include a plurality of storage devices, including, but not limited to, a RAID device, a distributed computing network, or the like.

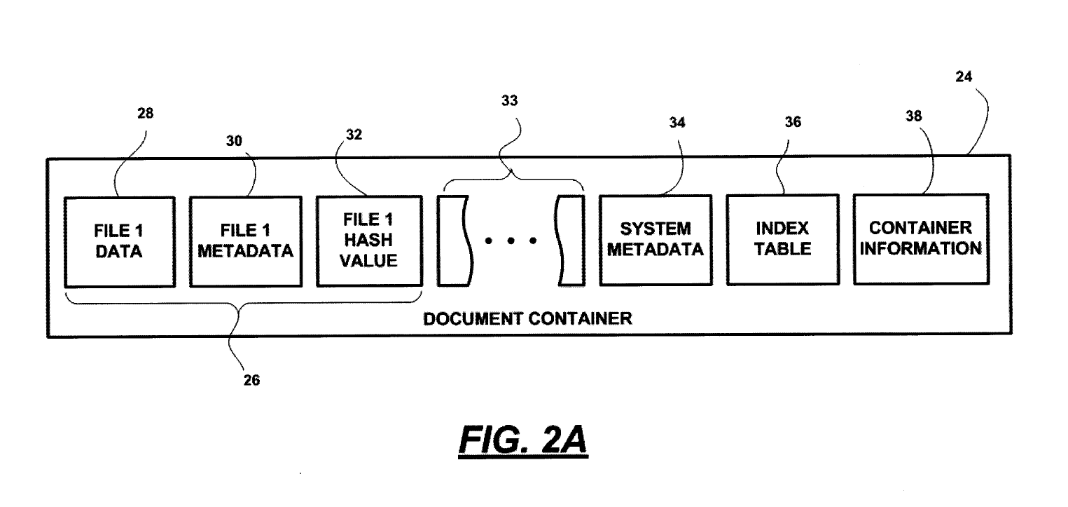

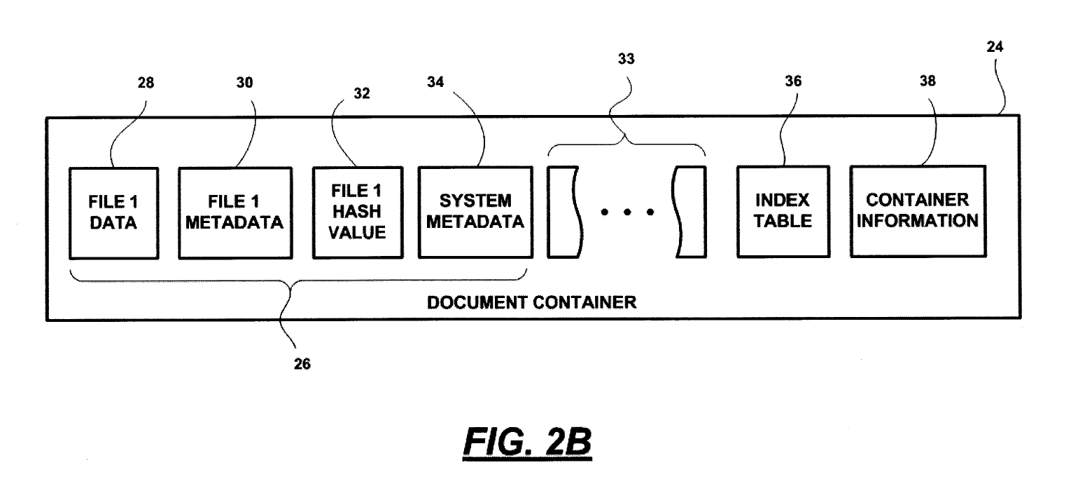

FIG. 2a shows an embodiment of a document container 24 according to an embodiment of the present invention. The document container 24 includes stored information obtained from a target storage device 16. The document container 24 logically groups information relating to each file stored therein as illustrated by a file package element 26. The file package element has a grouping of information for a given file, including a file data portion 28, a file metadata portion 30, and a hash value portion 32. Although a single file package 26 is shown for diagrammatic simplicity, the document container 24 can accommodate a plurality of file packages. This is illustrated by element 33.

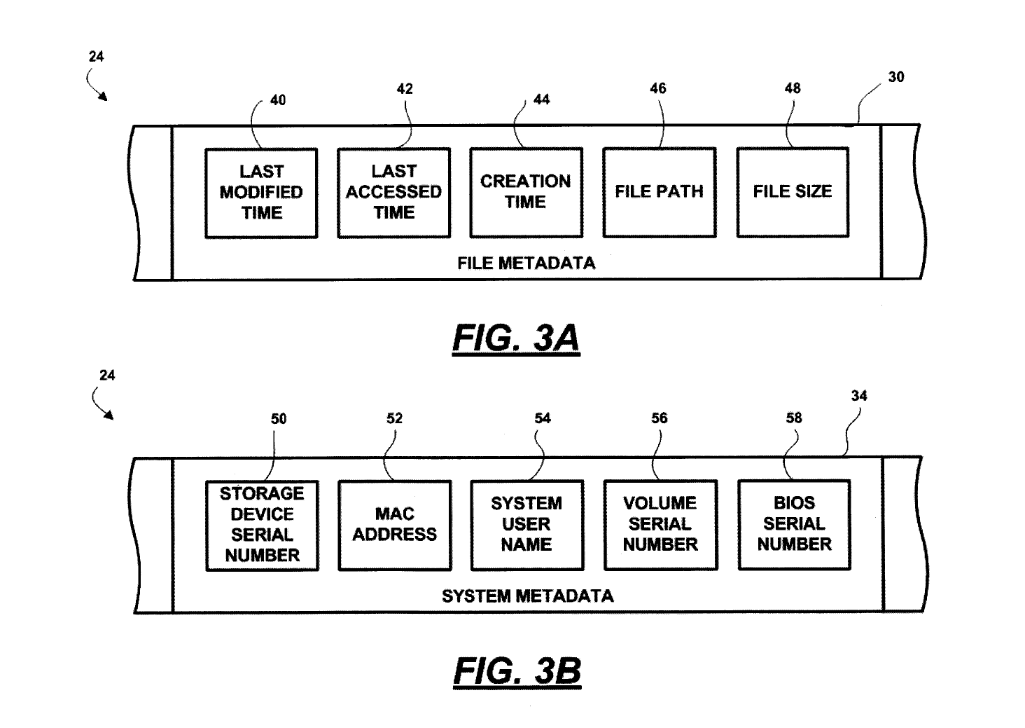

With continued reference to FIG. 2a, element 34 represents the logical grouping of system metadata relating to the target storage device 16 and/or to the target machine hosting the target storage device 20. Each of the elements 30,34 will be explained in further detail in the following disclosure relating to FIGS. 3a-3b. The document container 24 includes an index table 36 that contains reference information to other portions of the document container 24 for the purpose of indexing and facilitating a search within the document container 24. The container-information element 38 can include information relating to the document container 24 itself, including, but not limited to, the container's creation time, hash value, and/or user information.

FIG. 2b shows another embodiment of the document container 24. Here, the file package 26 also includes a system metadata portion 34. The logical association between the system metadata 34 and the file data 28, as modified from FIG. 2a, can allow for increased flexibility in indexing and searching each particular file package 26. This modified logical grouping can be useful in a scenario, for example, where it is desired to search a merged document container (as will be described in the following disclosure) for a set of files originating from a particular target storage device 16 and/or a particular target machine 20.

FIGS. 3a-3b show logical elements of the previously described document container 24 in greater detail. With reference to FIG. 3a, a file metadata element 30 is exemplarily shown containing five information portions: last modified time 40, last accessed time 42, creation time 44, file path 46, and file size 48. The information in each portion generally corresponds to the respective information on the target storage medium 16 at the time when that information was acquired. FIG. 3b shows a system metadata element 34 also including five information portions: storage device serial number 50, MAC address 52, system user name 54, volume serial number, and BIOS serial number. The five information elements listed above in each of FIG. 3A and FIG. 3B are not intended as an exclusive enumeration of all allowable types of information but are merely meant to guide and suggest as to a best mode of carrying out the present invention.

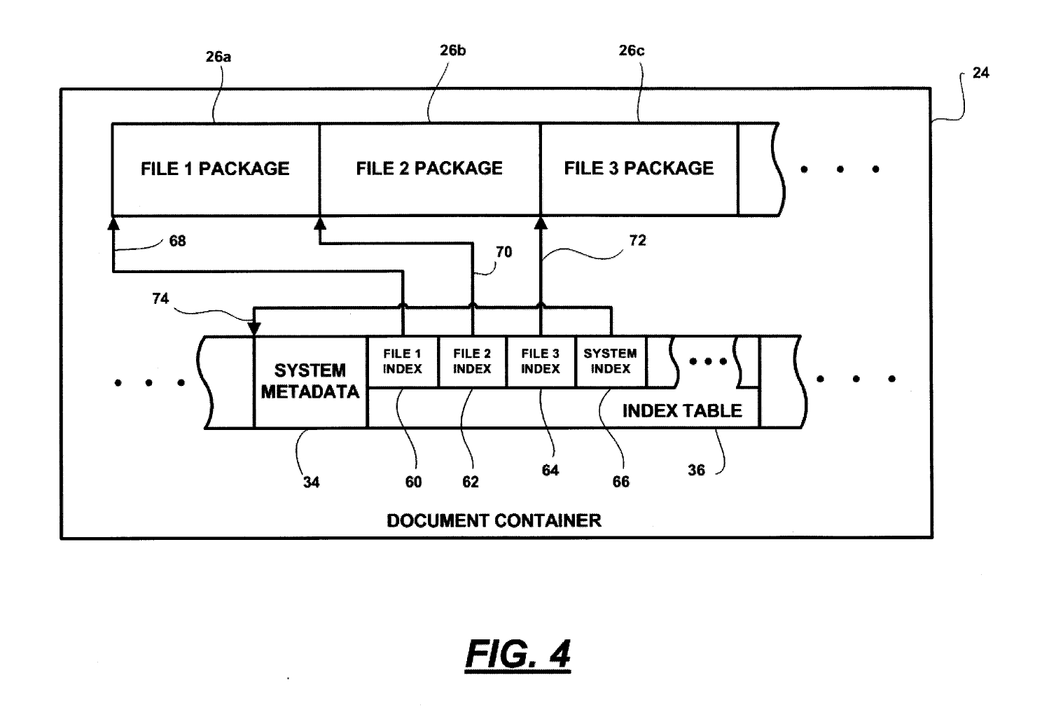

FIG. 4 shows a document container 24 with particular focus on the index table 36 of the container 24. The container 24 includes at least three file packages: 26a, 26b, and 26c; at least one system metadata element 34; and an index table 36 in accordance with the preceding disclosure. The index table 36 contains index reference portions 60, 62, 64, and 66 that each provide information for indexing and searching each corresponding file package. The index reference portions may include any information related to indexing or referencing, such as file metadata, keywords, full-text indexing, and system metadata. As shown by arrow elements 68, 70, and 72, each index reference portion is exemplarily shown to reference the offset of each corresponding file package 26a, 26b, and 26c within the document container 24. Additionally, arrow element 74 references system metadata element 34.

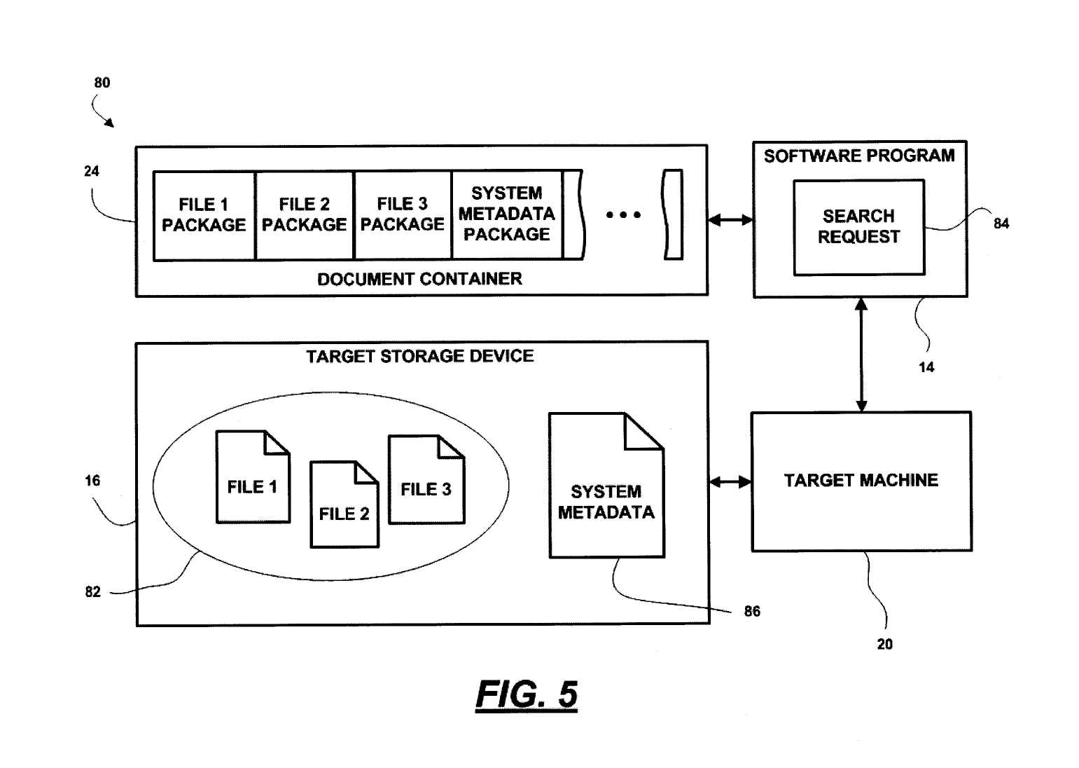

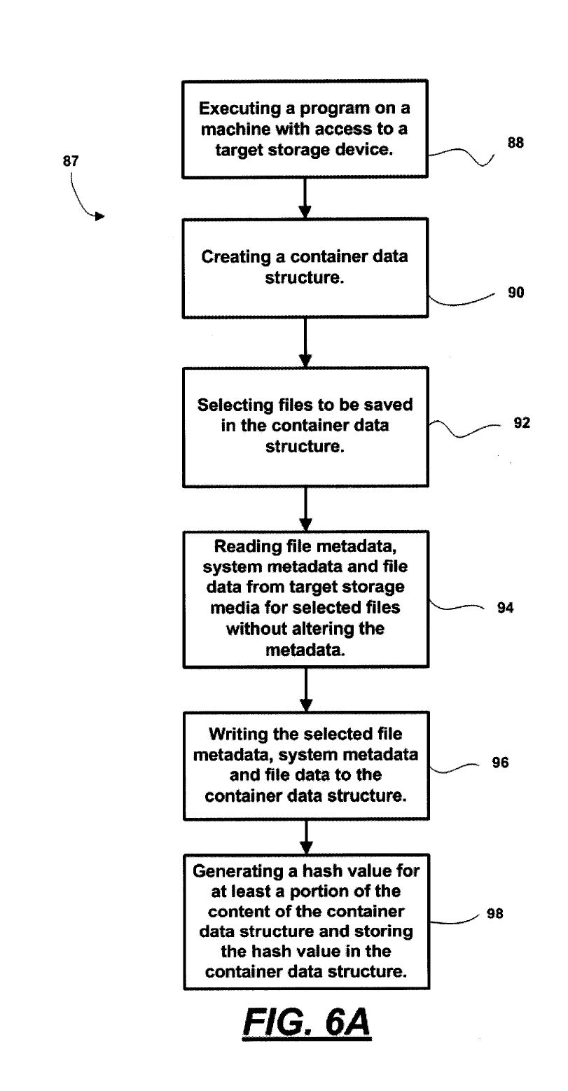

FIG. 5 shows a diagram illustrating a general method 80 for forming a document container in accordance with the present invention. Element 82 represents a set of relevant files to be encoded into a document container 24. The set of relevant files 82 may be determined by a search facilitated by the software program 14 on the target storage device 16 with respect to a search request 84 made by a user. In FIG. 5, three files are exemplarily shown as relevant files, and element 86 represents the system metadata associated with the target storage device 16 and the target machine 20 that may be hosting the storage device 16. The data portion and the metadata portion of each file among the relevant files 82 is sequentially copied into the document container 24 and the index table (not shown in FIG. 5) may update references to each file package accordingly, as described and shown in FIG. 4. Once the data and metadata portions of each file are encoded into the document container 24, the system metadata 86 is encoded into the container 24 and the index table may accordingly add a reference to the system metadata portion.

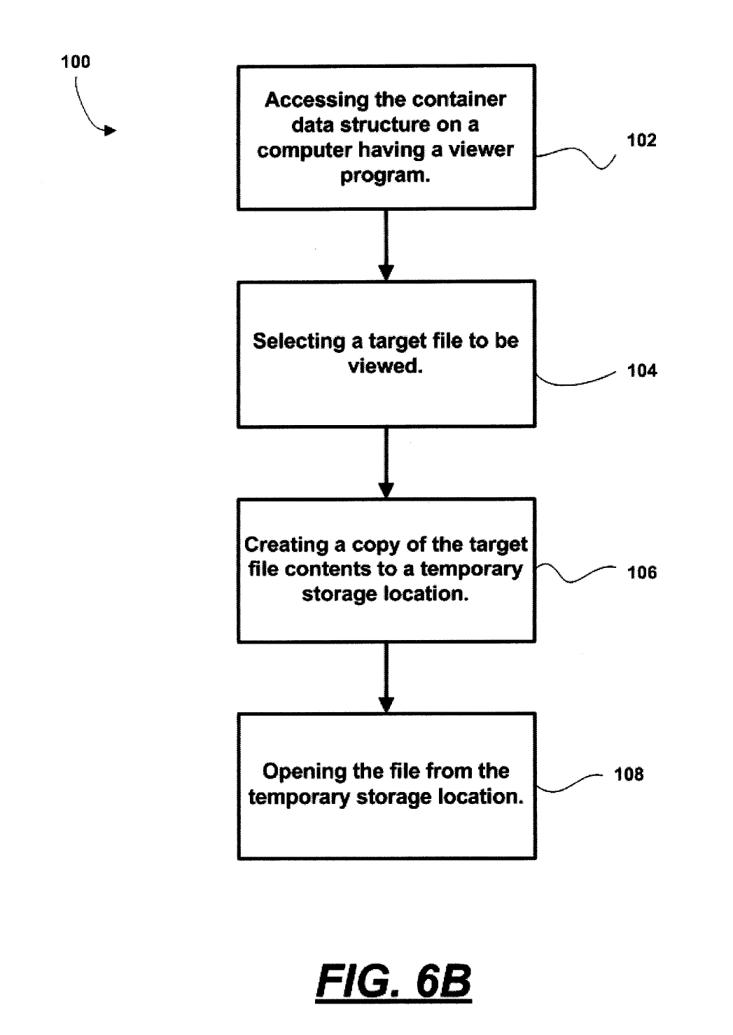

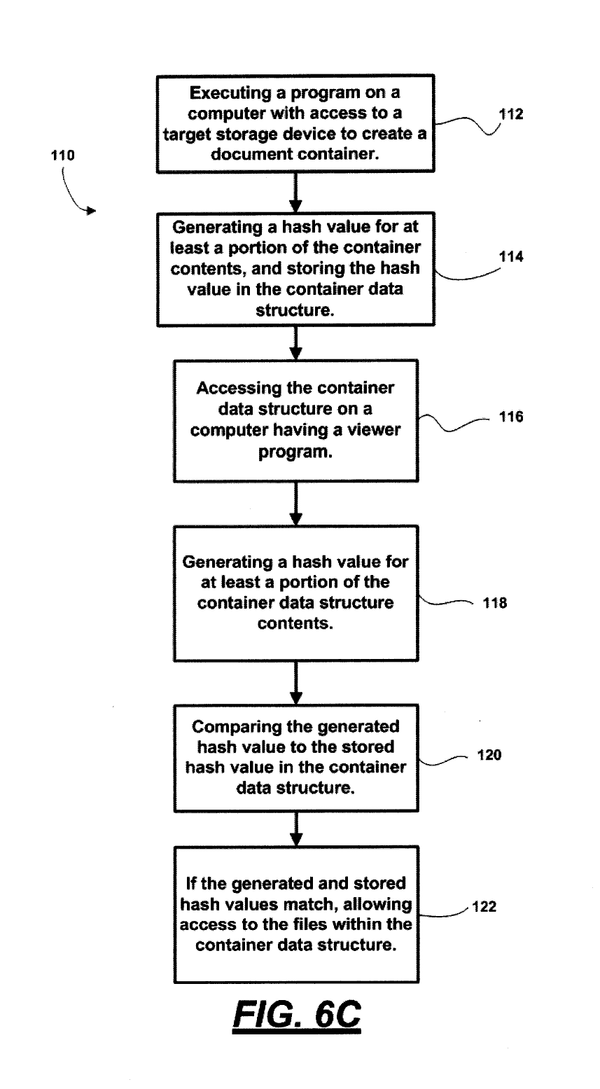

FIG. 6A shows a flow diagram 87 illustrating a method for creating a document container data structure in accordance with embodiments of the present invention. The first step 88 involves executing a software program on an investigating machine with access to a target storage device. Next, in step 90, a container data structure is created on a storage device associated with the investigating machine. The initially created document container may contain information associated with the container, such as creation time, user information, or the like. A user can then select files to be saved in the document container as shown in step 92. The files can be selected manually or through the result of a search request, such as a query search or a parameter search, or in any other way that would allow a user to selectively choose files. As an example of a query search, a user could specify a search for one or more words in at least a portion of each document on the target storage medium. A parameter search could be a search for all files with one or more common parameters, for example file extension.

Referring to element 94 of FIG. 6A, the software program reads the data and metadata associated with each relevant file, along with the system data associated with the target storage medium and/or the target machine without altering the original metadata. The file data, file metadata, and system metadata information read above may be stored in an intermediate buffer or in a temporary storage location as dictated by the particular environment and application. With respect to element 96, the file data, metadata, and system metadata information is then written to the document container in one or more logical blocks as described by the preceding disclosure. As shown by element 98, a hash value can be generated for at least a portion of the content within the document container and appended to a portion of the document container.

FIG. 6B shows a flow diagram 100 illustrating a method of viewing a file stored within a document container in accordance with embodiments of the present invention. The first step 102 involves accessing the document container on a computer with a viewer program capable of associating with the document container. As shown by element 104, a user can then select a target file to be viewed, after which the viewer program would create a copy of the target file contents to a temporary storage location. The storage location can be any location on a digital storage medium, such as hard disk drive space, a memory buffer, or the like. With respect to element 108, the viewer program would then open the target file from the temporary storage location, such that the user could view the contents of the duplicate file without altering the preserved data or its associated metadata stored within the document container.

With reference to FIG. 6C, a flow diagram 110 is shown illustrating a method of authenticating a document container encoded in a computer readable storage device, in which the container includes data derived from one or more target files. The first step 112 involves executing a software program on an investigating machine with access to a target storage device to create a document container on a storage device associated with the investigating machine. Next, as shown by element 114, a hash value of at least a portion of the document container is generated, and the hash value is encoded into a portion of the document container. The user can encrypt the document container, using any known method of encryption, and set the hash value as the private decryption key. Accordingly, a user who wishes to send the file to a recipient could preclude the recipient from accessing the file until the recipient generates a hash value and compares the generated hash value to the stored hash value, as shown by element 120. If the generated and stored hash values match, the recipient would have access to the document container, as shown by 122. The method implicitly verifies that the generated document container matches the received document container through the use of hash values.

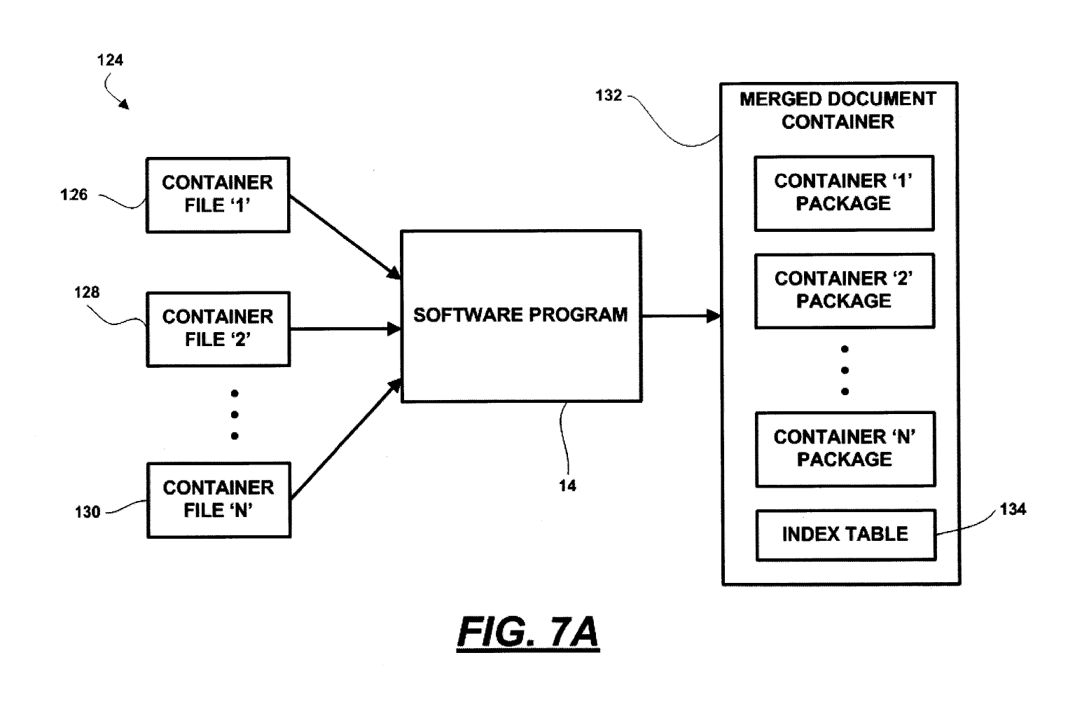

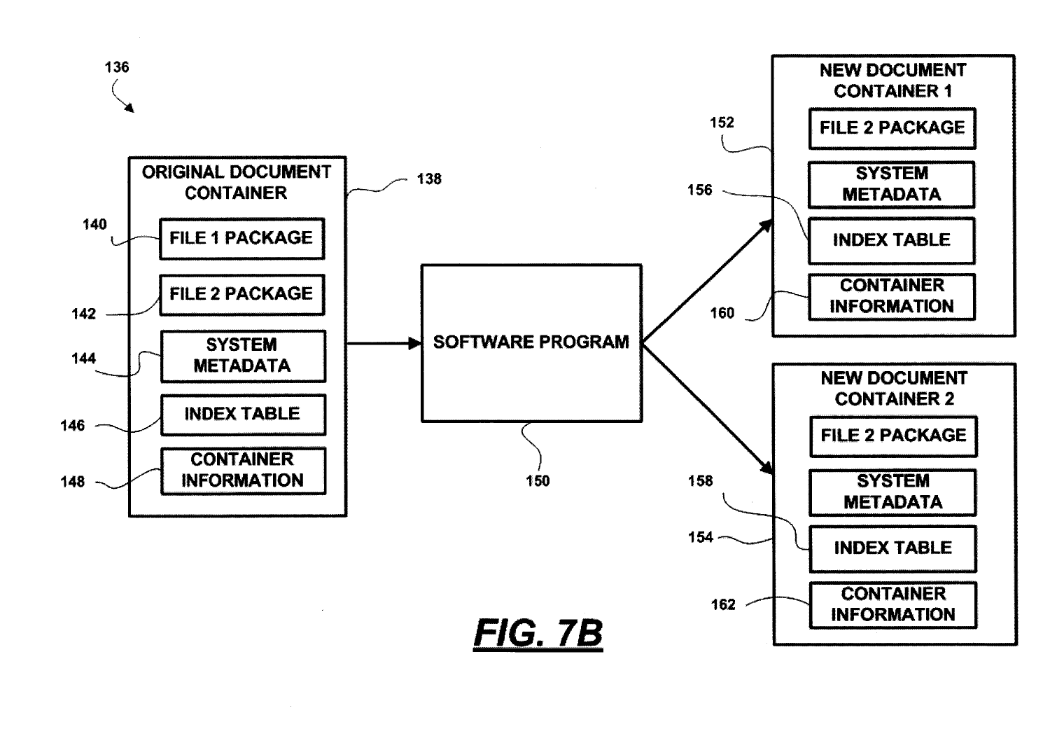

FIG. 7A shows a method 124 for merging a plurality of container files into a single container file in accordance with the present invention. Depending on the situation, several document container files may be generated and a user may wish to merge the files into a single file. In FIG. 6, several document containers are shown, each having one or more portions of information encoded therewithin, as discussed in the preceding disclosure. The software program 14 associates with each container file, 126, 128, and 130, as shown in FIG. 6, to generate a merged document container 132 with a copy of each container file encoded therewithin. The merged file can also contain an index reference element 134 to index and provide references to each container package 136, 138, and 140 within the merged document container 132.

FIG. 7B illustrating a diagram 136 showing a method of creating one or more new document containers from at least a portion of an existing document container. An original document container 138 is shown having at least two file packages, 140 and 142, system metadata element 144, index table 146, and container information element 148. It may be desirable to split a document container into several new document containers, with each new container having one or more files from the original container. As shown in FIG. 7B, the software program 150 associates with the original document container 138 to create two new containers, 152 and 154, with each new container having a file package from the original container 138, along with the system metadata element 144, encoded therewithin. Although the invention contemplates the software program 150 having a graphical user interface to allow a user to select files for the creation of a new container, any suitable interface may be used as dictated by the particular situation.

Still referring to FIG. 7B, he index tables 156, 158 of each new container 152,154, respectively, would be modified to reflect the quantity of file packages and the reference information to each file package within each of the new containers. The container information elements 160, 162 could include any relevant information about the new containers, such as creation time, user information, or the like. Furthermore, information from the container information element 148 of the original document container 138 could be included to allow a user to track the information stored within the new container to its conception to create a “chain of custody”. In this variation, the document container includes information regarding chain of custody of the information contained therein. For example, in this variation, the document container includes additional information beyond that describing the original target medium from which the documents originated. Examples of such information, include but are not limited to, the name of the person collecting the information as well as all media and users accessing the document containers. In some refinements, the document container is operable to collect at least a portion of this information without user intervention or with minimal intervention. In other refinements, a users enters relevant information into appropriate fields. Chain of custody information is useful for tracking the history of a given file that might have been extracted from a previously created container. In this instances, there will be metadata associated with the initial document container as well subsequent containers that the file has been incorporated into. This way the history of a file can be traced back to the original target medium.

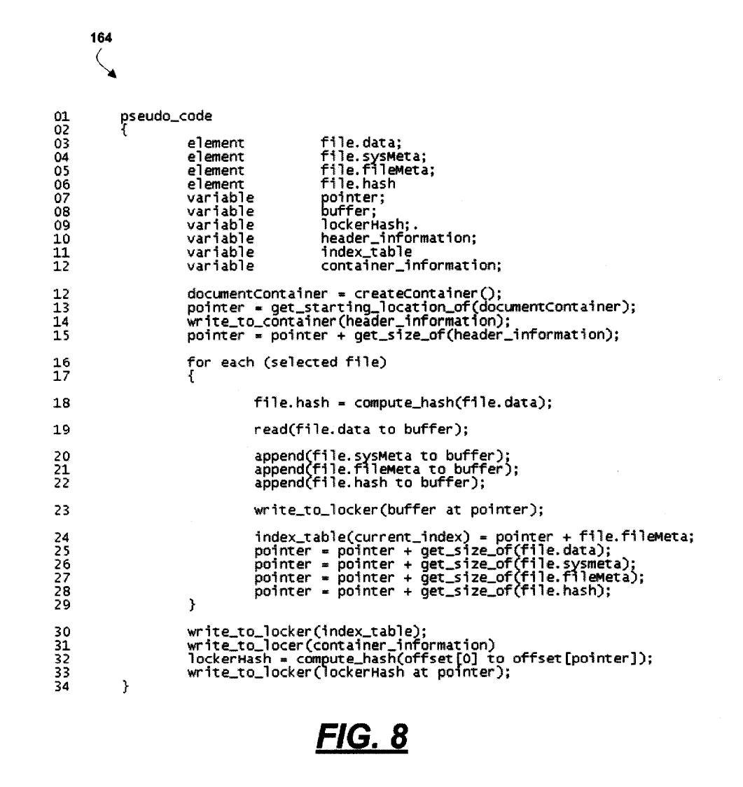

FIG. 8 shows pseudo code 164 that programmatically describes the method of creating a document container data structure in accordance with embodiments of the present invention. Although the invention contemplates using a high-level programming environment with a supporting framework, such as Microsoft .NET or Java Virtual Machine, to accommodate devices of different computer architectures, any other suitable programmatic method, such as low-level native programming or ASIC programming, may be used. Furthermore, the pseudo code shown is not meant to exclusively enumerate through the different methods of creating a document container data structure, but is merely meant to represent the best mode known to the inventors.

Each line within the code 164 corresponds to a number in a column on the left side of the code 164. Lines 3-12 correspond to the declaration of temporary storage elements and variables. In lines 12-15, a document container data structure is created with header information encoded therewithin, and the file pointer is incremented to accordingly point to the end of the header information portion of the container file. As described above, the document container file can be created on a storage device in association with an investigating machine, or the file can instead be created on a storage location on the target storage device, as dictated by the particular situation.

Still referring to FIG. 8, lines 16-29 correspond to a loop that applies to each file selected by a user to be stored within the document container. A loop iteration starts at line 18, where a hash value is computed for the particular file and assigned to a temporary storage element, “file.hash” in this case. Next, at lines 19-22, each of the file data, system metadata, file metadata, and file hash value, are appended to a buffer reference used to temporarily store the data. Although the invention contemplates using a portion of random access memory to store the data referenced by the buffer, any storage location, including a hard disk drive, non-volatile magnetic media, or the like, can be used as directed by the resources in the particular operating environment.

In line 23 of FIG. 8, the contents referenced by the buffer are written to the document container at the location pointed to by the file pointer. The file pointer is then accordingly incremented by an offset determined by the combined size of the file data, system metadata, file metadata, and file hash value. The loop, spanning lines 16-29, proceeds in this manner until each user-selected file is written to the document container. Next, the index table and container information elements are written to the document container at the location pointed to by the file pointer. A hash value is then computed for the contents of the document container, wherein the hash value spans the contents from the start of the document container to the end of the container information element. The hash value is then appended to the end of the document container.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

While several embodiments of the present invention have been illustrated and described, it is not intended that these embodiments illustrate and describe all possible forms of the invention. Rather, the words used in this section are words of description rather than limitation, and various changes may be made without departing from the spirit and scope of the invention.

What is claimed is:

1. A container data structure encoded in a computer readable medium, the container data structure comprising:
file data copied from a first target file, the first target file encoded on a target digital storage medium; and
metadata associated with the first target file, the metadata associated with the first target file including original access time information, original creation time information, original modified time information, and an original file path.

2. The container data structure of claim 1 further comprising information encoded therewith identifying the target digital medium or identifying a target machine hosting the target digital storage medium.

3. The container data structure of claim 2 wherein the information identifying the target digital medium includes a hard drive serial number, a mac addresses, operating system serial number, user names, volume serial number, bios serial numbers, container data structure created time, container data structure modified time, container data structure accessed time, and combinations thereof.

4. The container data structure of claim 2 further comprising hash data encoded therewith.

5. The container data structure of claim 2 wherein the hash data is derived from file data copied from a first target file, the metadata associated with the first target file, and combinations thereof.

6. The container data structure of claim 1 further comprising software registration information encoded therewith for a software program used to form the container data structure.

7. The container data structure of claim 1 further comprising:
file data encoded therewith from a second target file, the second target file encoded on the target digital storage medium; and
metadata encoded therewith associated with the second target file, the metadata associated with the second target file including original access time information, original creation time information, original modified time information, and an original file path.

8. The container data structure of claim 6 further comprising:
file data encoded therewith from one or more additional target files, the one or more additional target files encoded on the target digital storage medium; and
metadata encoded therewith associated with each of the one or more additional target files, the metadata associated with each of the one or more additional target files including original access time information, original creation time information, original modified time information, and an original file path for each of the one or more additional target files.

9. The container data structure of claim 1 further comprising break makers encoded therewith that divide sections of the container data structure.

10. The container data structure of claim 1 further comprising one or more file references encoded therewith that allow locating of file data within the container data structure.

11. The container data structure of claim 1 further comprising one or more items from a master file metadata database encoded therewith.

12. A method of forming a container data structure, the container data structure comprising:
file data copied from a first target file, the first target file encoded on a target digital storage medium; and
metadata associated with the first target file, the metadata associated with the first target file including original access time information, original creation time information, original modified time information, and an original file path, the method comprising:
a) copying the first target file to a storage location to form the file data copied from a first target file;
b) associating a copy of original metadata with the file data copied from a first target file.

13. The method of claim 12 wherein the first target file is copied in a manner in a manner that prevent alteration of the first target file and the original associated metadata.

14. The method of claim 12 wherein the first target file is copied in a manner to prevent writes to the target storage medium.

15. The method of claim 12 wherein the container data structure includes information identifying the target digital medium.

16. The method of claim 12 wherein the information identifying the target digital medium includes a hard drive serial number, a mac addresses, operating system serial number, user names, volume serial number, bios serial numbers, container data structure created time, container data structure modified time, container data structure accessed time, and combinations thereof.

17. The method of claim 12 further comprising:
c) searching for a predetermined group of files; and
d) repeating steps a)-b) a sufficient number of times to incorporate each file of the predetermined group of files into the container data structure.

18. A method of viewing a container data structure, the container data structure comprising:
file data copied from one or more target files, the one or more target files encoded on a target digital storage medium; and
metadata associated with the one or more target files, the metadata associated with the one or more target files including original access time information, original creation time information, original modified time information, and an original file path, the method comprising:
a) providing a user with a listing of the file data and/or metadata included in the container data structure.

19. The method of claim 18 further comprising:
b) exporting data and/or metadata from the container data structure.

20. The method of claim 19 further comprising:
c) importing data and/or metadata into the container data structure by the steps of:
i) copying file data from one or more additional target files to the container data structure; and
ii) associating a copy of original metadata with the file data.

21. A method of authenticating a file container data structure encoded in a computer readable medium, the container data structure including file data derived from one or more target files, the method comprising:
a) associating a hash value with the container data structure; and
b) requiring authentication of the hash value as a prerequisite to viewing content in the container data structure.

22. The method of claim 21 wherein the container data structure comprises:
file data copied from a first target file, the first target file encoded on a target digital storage medium; and
metadata associated with the first target file, the metadata associated with the first target file including original access time information, original creation time information, original modified time information, and an original file path.
